(19) United States
(12) Patent Application Publication
(10) Pub. No.: US 2023/0041328 A1
(43) Pub. Date: Feb. 9, 2023

(54) SYSTEM AND METHOD FOR DYNAMIC DIGITAL SURVEY CHANNEL SELECTION

(71) Applicant: NICE LTD., Ra'anana (IL)

(72) Inventors: Pavan LAHOTI, Pune (IN); Shivdatta MORWADKAR, Pune (IN); Yuval SHACHAF, Even Yehuda (IL)

(21) Appl. No.: 17/392,271

(22) Filed: Aug. 3, 2021

(51) Int. Cl. G06Q 30/02; H04L 29/08; G06N 20/00

(52) U.S. Cl. CPC G06Q 30/0203; H04L 67/22; H04L 67/306; G06N 20/00

(57) ABSTRACT

A computerized-method for dynamic digital-survey-channel selection is provided herein. In a computerized system having a processor, a memory to store a database of survey responses and a database of customers details, and a Voice of the Customer (VOC) platform having an outbound-message Application Programming Interface (API) to send a digital survey to a customer, via a plurality of digital survey channel types, when a customer is nominated for a digital survey, the computerized-method included operating by said processor, a digital-survey-channel-selection module. The digital-survey-channel-selection module includes (i) determining a digital-survey-channel type to elevate customers-response-rate to a digital survey; and (ii) sending the determined digital-survey-channel type to the outbound-message API to trigger the digital survey to a computerized device of the customer, via the determined digital-survey-channel type.

### TECHNICAL FIELD

The present disclosure relates to the field of machine learning algorithms to select an optimal digital survey channel for a survey, such that the selected digital survey channel will boost a response rate of customers, i.e., survey respondents.

### BACKGROUND

In today's world of digital transformation, customers interact with companies via various digital channels. For example, text messaging such as WhatsApp, Facebook messenger, Messenger, Short Message Service (SMS) but not limiting to among other digital channel types. In continuation to the interaction of consumers with the companies, customer details may be nominated for post interaction survey to collect the Voice of Customer (VoC), which is customer's feedback about recent interaction that the customer had via the digital channels or about other service provided by the company. The customer may complete the interaction at a touchpoint, e.g., with an agent or via a website or via automated chat channels or in stores.

To improve customer experience and to better meet customers' expectations, companies strive to receive the highest volume of feedback, e.g., maximum response rate to a digital survey.

Therefore, it is of paramount importance to identify a digital survey and a digital channel automatically based on customers' preferences and profile, e.g., product, geographical location, business, age etc. It is assumed that reaching out to customers according to their preferred digital channel type, might make the customers more comfortable and they may be more motivated to respond to the survey, thus increasing the response rate to the digital survey.

Accordingly, there is a need for a technical solution for a dynamic digital-survey-channel selection.

### SUMMARY

There is thus provided, in accordance with some embodiments of the present disclosure, a computerized-method for a dynamic digital-survey-channel selection.

Furthermore, in accordance with some embodiments of the present disclosure, in a computerized system that includes a processor, a memory to store a database of survey responses and a database of customers details, and a Voice of the Customer (VOC) platform having an outbound-message Application Programming Interface (API) to send a digital survey to a customer, via a plurality of digital survey channel types, when a customer is nominated for a digital survey, operating by said processor, a digital-survey-channel-selection module, the digital-survey-channel-selection module may include: (i) determining a digital-survey-channel type to elevate customers-response-rate to a digital survey; and (ii) sending the determined digital-survey-channel type to the outbound-message API to trigger the digital survey to a computerized device of the customer, via the determined digital-survey-channel type. The digital survey may be conducted via the determined digital-survey-channel type that may be running on the computerized device of the customer. The computerized device of the customer may be at least one of: a mobile device, a tablet, a laptop or a desktop.

Furthermore, in accordance with some embodiments of the present disclosure, the determining may be preconfigured to be (i) dynamic; or (ii) based on a preconfigured multi-parameter rule.

Furthermore, in accordance with some embodiments of the present disclosure, when the determining is preconfigured to be dynamic, the determining is operated by Machine learning (ML) models and performed by: (i) predicting customers-response-probability for each digital-survey-channel type of the plurality of digital survey channel types, based on one or more features, which are retrieved from the database of survey responses and the database of customers details; and (ii) selecting the digital-survey-channel type that is having a highest predicted customers-response-probability.

Furthermore, in accordance with some embodiments of the present disclosure, the determined digital-survey-channel type may be associated with the customer and a digital survey is sent via the outbound-message API, to the computerized device of the customer, via the associated digital-survey-channel type.

Furthermore, in accordance with some embodiments of the present disclosure, when the determining may be based on a preconfigured multi-parameter rule, the determining may be operated by parameters of the preconfigured multi-parameter rule and data of the customer that is retrieved from the database of customers details.

Furthermore, in accordance with some embodiments of the present disclosure, during a configuration of a digital-survey-channel type and other parameters of the preconfigured multi-parameter rule via an interface, by a user, the computerized method may be further comprising selecting a digital-survey-channel type and when the digital-survey-channel type that was configured by the user is different from the selected digital-survey-channel type, the selected digital-survey-channel type may be displayed via the interface, as part of a recommendation for a digital-survey-channel type.

Furthermore, in accordance with some embodiments of the present disclosure, the selecting of the digital-survey-channel type is operated by: (i) retrieving ‘n’ data entries from the database of customers details according to the other parameters of the preconfigured multi-parameter rule and a preconfigured period of time; and (ii) predicting a customers-response-probability for each digital-survey-channel type of the plurality of digital survey channel types, based on the retrieved ‘n’ data entries.

Furthermore, in accordance with some embodiments of the present disclosure, the predicting of the customers-response-probability for each digital-survey-channel type of the plurality of digital survey channel types may be operated by: (i) applying a digital-survey-channel type for each data entry, from the ‘n’ data entries, to predict by ML models a customers-response-probability for each data entry and then calculating an average customers-response-probability for the ‘n’ data entries for each digital-survey-channel type; and (ii) selecting a digital-survey-channel type from the plurality of digital survey channel types based on a highest average customers-response-probability.

Furthermore, in accordance with some embodiments of the present disclosure, the customer may be nominated for the digital survey after an interaction at a touchpoint of at least one of: an agent, a website, an automated chat channel and a store.

There is further provided, in accordance with some embodiments of the present disclosure, a computerized-system for a dynamic digital-survey-channel selection.

Furthermore, in accordance with some embodiments of the present disclosure, the computerized-system may include a processor, a memory to store a database of survey responses and a database of customers details, and a Voice of the Customer (VOC) platform having an outbound-message Application Programming Interface (API) to send a digital survey to a computerized device of customer, via a plurality of digital survey channel types.

Furthermore, in accordance with some embodiments of the present disclosure, when a customer is nominated for a digital survey, the processor may be configured to operate a digital-survey-channel-selection module.

Furthermore, in accordance with some embodiments of the present disclosure, the digital-survey-channel-selection module may be configured to: (i) determine a digital-survey-channel type to elevate customers-response-rate to a digital survey; and (ii) send the determined digital-survey-channel type to the outbound-message API to trigger the digital survey to a computerized device of the customer, via the determined digital-survey-channel type.

### BRIEF DESCRIPTION OF THE DRAWINGS

FIG. 1 schematically illustrates a high-level diagram of a system for a dynamic digital-survey-channel selection, in accordance with some embodiments of the present disclosure;

FIG. 2 is a high-level workflow of a computerized-method for a dynamic digital-survey-channel selection, in accordance with some embodiments of the present disclosure;

FIG. 3 is a high-level workflow of a data flow between different services, in accordance with some embodiments of the present disclosure;

FIG. 4A is a high-level workflow of decision flow of a rule-based engine, in accordance with some embodiments of the present disclosure;

FIG. 4B is a high-level workflow of rule evaluation, in accordance with some embodiments of the present disclosure;

FIG. 5 is a high-level workflow of channel association and send survey, in accordance with some embodiments of the present disclosure;

FIG. 6A is a high-level workflow of a channel configuration flow, in accordance with some embodiments of the present disclosure;

FIG. 6B is a screenshot of channel configuration Graphical User Interface (GUI), in accordance with some embodiments of the present disclosure; and

FIGS. 7A-7B are screenshots of ‘n’ entries in a database retrieved according to parameters of the preconfigured multi-parameter rule, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the at that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Companies are collecting feedback about recent interaction that the customer had at a touchpoint, such as with an agent in a contact center via a digital channel. It may be significant to identify or determine a digital channel type based on customer's preferences and profile, such as product, geographical location, business, age etc. to increase the response rate of the customers.

According to some embodiments of the disclosure, it is desired that a system user, such as a program manager, while designing a digital survey, may have the ability to define multi parameter rules, which would automatically select a digital channel type, based on customer's preferences and profile that have been previously captured by the system of the contact center.

According to some embodiments of the disclosure, these multiple parameters may be modeled using Machine Learning (ML) algorithms, according to historical data to get recommendations for a digital channel type with the highest probability of receiving a survey response, while defining the multi parameter rules.

According to some embodiments of the disclosure, suitable digital channel type recommendations during a configuration of multi parameter rules, by a user or right after a customer has been nominated for a digital survey, would help the program manager to yield the best benefit from the historical data, e.g., customer's preferences and profile, which were captured by feedback systems, thus increasing the response rate to the digital survey.

According to some embodiments of the disclosure, based on the multi parameter rules or criteria which were defined in the system, or alternatively recommendations for digital channel type that may be provided by ML algorithms, a system user, such as program manager should be able to send digital surveys via a variety of digital channel types, such that a maximum response rate may be achieved, in a seamless manner.

Therefore, there is a need for a technical solution for a dynamic digital-survey-channel selection to maximize a response rate to a digital survey.

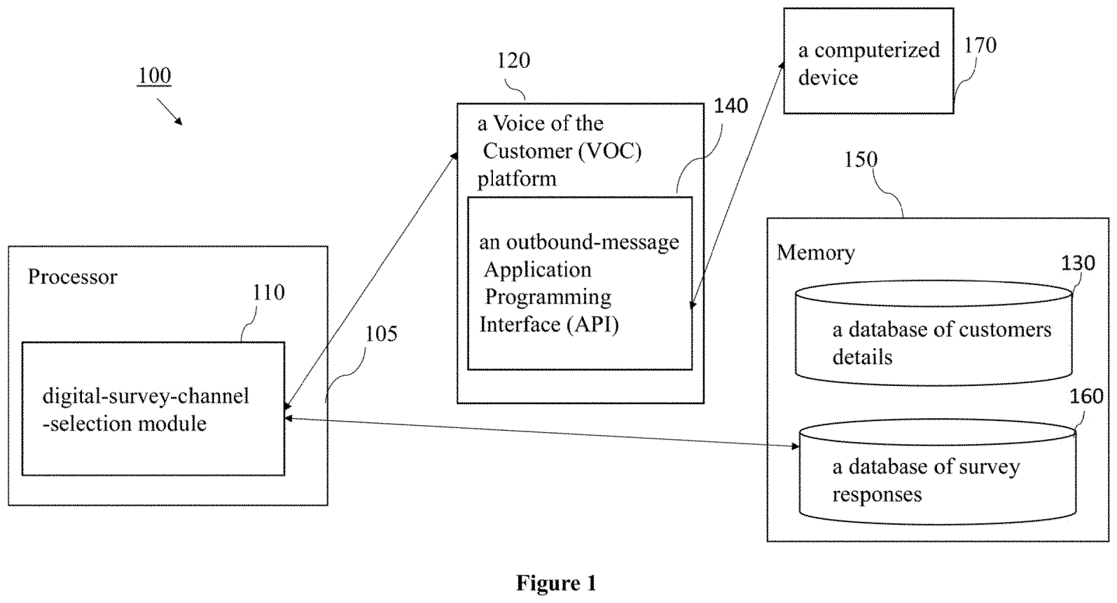

FIG. 1 schematically illustrates a high-level diagram of a system for a dynamic digital-survey-channel selection, in accordance with some embodiments of the present disclosure.

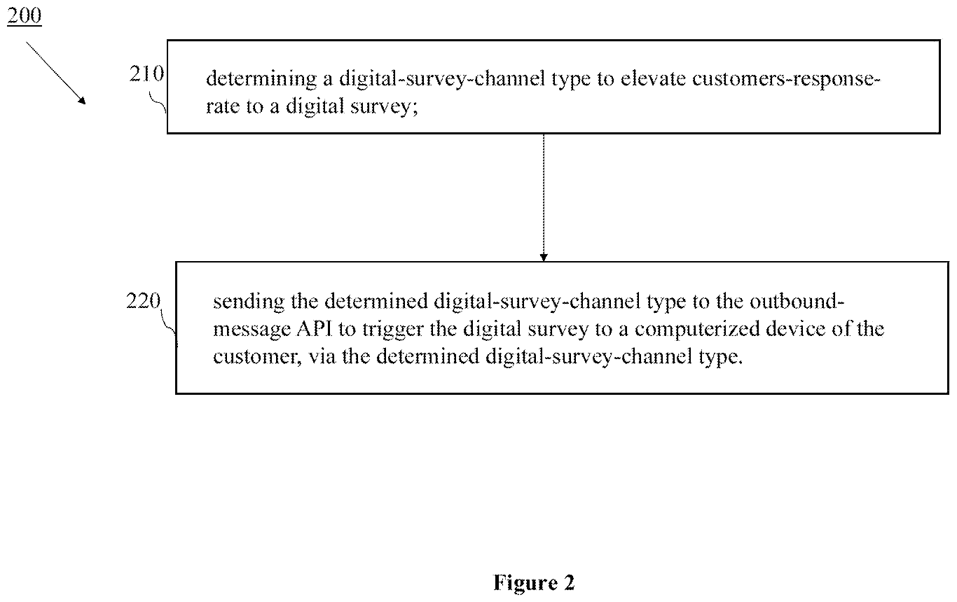

According to some embodiments of the disclosure, in a computerized system, such as a system for a dynamic digital-survey-channel selection 100, that is having a processor, such as processor 105, a memory, such as memory 150 to store a data storage, such as a database of survey responses 160 and a data storage, such as database of customers details 130, and a platform to receive customers feedback, such as Voice of the Customer (VOC) platform 120, which is having an outbound-message Application Programming Interface (API) 140 to send a digital survey to a customer, via a plurality of digital survey channel types, when a customer is nominated for a digital survey, the processor 105 may be operating a module, such as digital-survey-channel-selection module 110 and such as digital-survey-channel-selection module 200 in FIG. 2.

According to some embodiments of the disclosure, the module, such as digital-survey-channel-selection module 110, may include: (i) determining a digital-survey-channel type to elevate customers-response-rate to a digital survey; and (ii) sending the determined digital-survey-channel type to the outbound-message API to trigger the digital survey to a computerized device of the customer, such as computerized device 170, via the determined digital-survey-channel type. The computerized device may be a mobile device, a tablet, a laptop or a desktop.

According to some embodiments of the disclosure, the determining may be preconfigured to be (i) dynamic; or (ii) based on a preconfigured multi-parameter rule.

According to some embodiments of the disclosure, a user may configure the system, such as the system for a dynamic digital-survey-channel selection 100, for an automated digital channel type selection, e.g., dynamic or to be based on a preconfigured multi-parameter rule, e.g., manual.

According to some embodiments of the disclosure, in case the system, such as the system for a dynamic digital-survey-channel selection 100, has been configured to be based on a preconfigured multi-parameter rule, e.g., manual, a user such as a program manager, may create multi-parameter rules for dynamic digital channel selection, based on customer's preferences and profile.

According to some embodiments of the disclosure, when the determining is based on a preconfigured multi-parameter rule, as shown in FIG. 613, the determining may be using ML algorithms and operated by parameters of the preconfigured multi-parameter rule and data of the customer that is retrieved from the database of customers details.

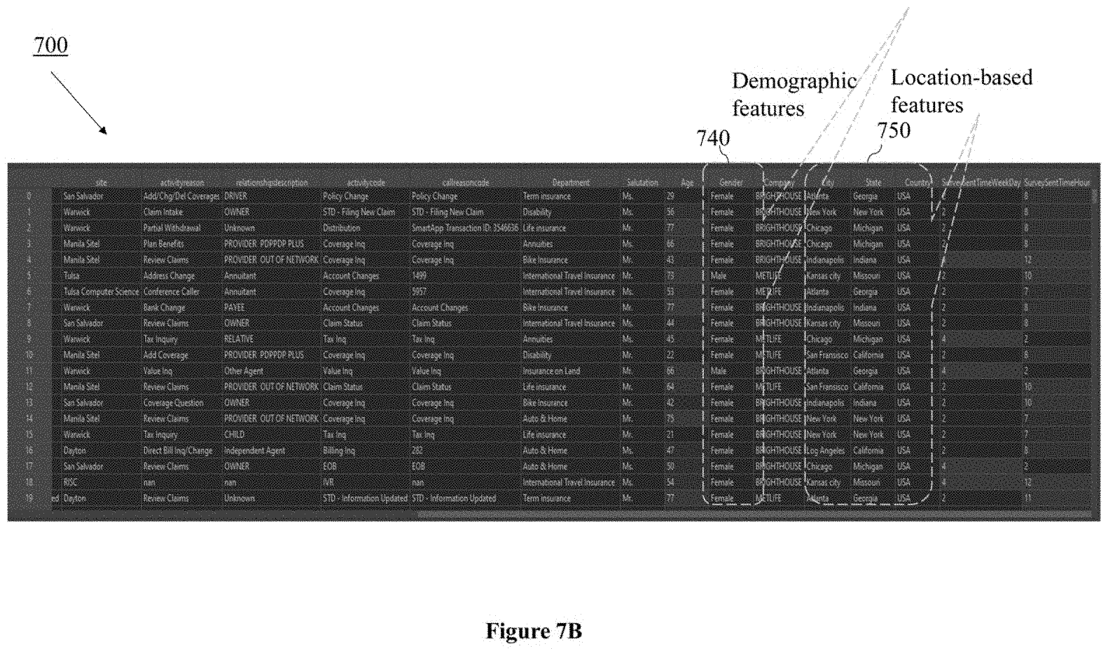

According to some embodiments of the disclosure, the system, such as the system for a dynamic digital-survey-channel selection 100, may associate i.e., determine a digital channel type, based on historical data analysis of customer's preferences and profile, as shown in FIGS. 7A-7B, using machine learning algorithms.

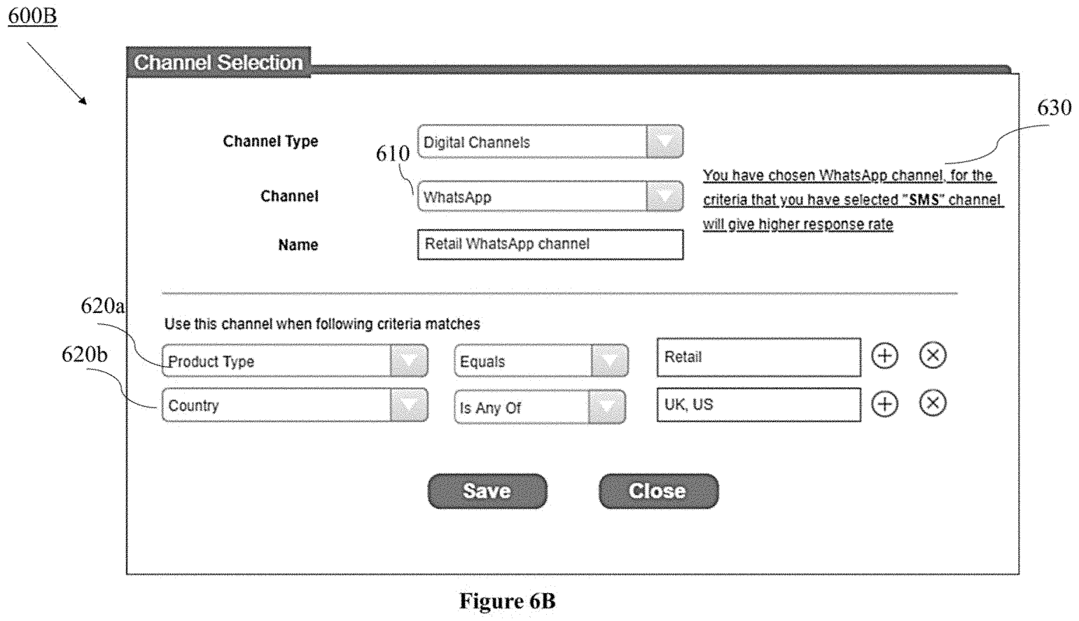

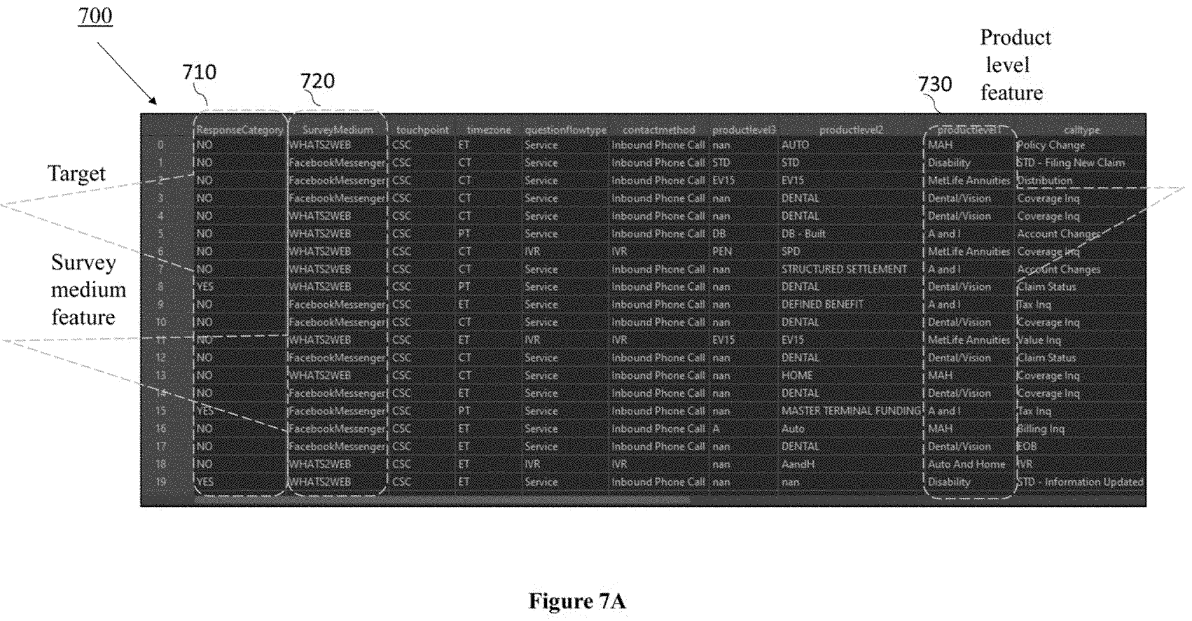

According to some embodiments of the disclosure, during a configuration of a digital-survey-channel type and other parameters of the preconfigured multi-parameter rule, via an interface, such as the screenshot of channel configuration Graphical User Interface (GUI) 600 in FIG. 6B, by a user, a module, such as digital-survey-channel-selection module 110, and such as digital-survey-channel-selection module 200 in FIG. 2, in the system, such as the system for a dynamic digital-survey-channel selection 100, may further select a digital-survey-channel type and when the digital-survey-channel type that was configured by the user, e.g., channel 610 in FIG. 6B, is different from the selected digital-survey-channel type, e.g., Short Message Service (SMS) channel, the selected digital-survey-channel type e.g. SMS channel, may be displayed via the interface as shown, for example in a screenshot of channel configuration Graphical User Interface (GUI) 600 in FIG. 6B, as part of a recommendation for a digital-survey-channel type which may maximize the response rate of the customers to the digital survey, based on ML algorithms. For example, recommendation 630 in FIG. 6B.

According to some embodiments of the disclosure, the selecting of the digital-survey-channel type may be operated by: (i) retrieving ‘n’ data entries from the database of customers details 130 according to the other parameters of the preconfigured multi-parameter rule and a preconfigured period of time; and (ii) predicting a customers-response-probability for each digital-survey-channel type of the plurality of digital survey channel types, based on the retrieved ‘n’ data entries. For example, the retrieved ‘n’ data entries may be the data entries as shown in FIGS. 7A-7B.

According to some embodiments of the disclosure, the other parameters of the preconfigured multi-parameter rule, may be product type and country as shown, for example, in a screenshot of channel configuration Graphical User Interface (GUI) 600 in FIG. 6B, a parameter, such as product type, where the rule criterion is that the product type equals retail 620a in FIG. 6B and a parameter such as parameter country, where the rule criterion is that the county is any of UK and US 620b in FIG. 6B.

According to some embodiments of the disclosure, the ‘n’ data entries from the database of customers details 130, according to the other parameters of the preconfigured multi-parameter rule, such as the rule, shown in a screenshot of channel configuration Graphical User Interface (GUI)600 in FIG. 6B, during a preconfigured period of time, may be for example, product level 730 in FIG. 7A and location based features 750 in FIG. 7B.

According to some embodiments of the disclosure, information in the database of customers details 130, may be imported from several sources, for example, from a web source, such as a system interface to upload, Secure File Transfer Protocol (SFTP), or Application Programming Interface(API), in another example, Customer Relationship Management (CRM) systems and external systems. The information may include details of a customer, such as profile information, preferences and more. The information may be imported via files in various formats, such as Comma Separated Values (CSV) or JavaScript Object Notation (JSON) format. A data importer element (not shown) may validate and format the data.

According to some embodiments of the disclosure, a customer may be nominated for the digital survey, after an interaction with a company at a touchpoint of at least one of: an agent, a website, an automated chat channel and a store.

FIG. 2 is a high-level workflow of a computerized-method for a dynamic digital-survey-channel selection 200, in accordance with some embodiments of the present disclosure.

According to some embodiments of the disclosure, operation 210 may comprise determining a digital-survey-channel type to elevate customers-response-rate to a digital survey.

According to some embodiments of the disclosure, a customer may be nominated for the digital survey after an interaction at a touchpoint of at least one of: an agent, a website, an automated chat channel and a store.

According to some embodiments of the disclosure, the determined digital-survey-channel type may be associated with a customer and a digital survey may be sent via an Application Programming Interface (API), such as an outbound-message API 140 in FIG. 1, to a computerized device of the customer, via the associated digital-survey-channel type.

According to some embodiments of the disclosure, the determining may be preconfigured to be (i) dynamic; or (ii) based on a preconfigured multi-parameter rule.

According to some embodiments of the disclosure, when the determining is preconfigured to be dynamic, the determining may be operated by Machine learning (ML) models and performed by: (i) predicting customers-response-probability for each digital-survey-channel type of the plurality of digital survey channel types, based on one or more features, which are retrieved from a data store, such as the database of survey responses 160 in FIG. 1 and the database of customers details 130 in FIG. 1 and (ii) selecting the digital-survey-channel type that is having a highest predicted customers-response-probability.

According to some embodiments of the disclosure, when the determining is based on a preconfigured multi-parameter rule, such as the rule, shown in a screenshot of channel configuration Graphical User Interface (GUI) 600 in FIG. 68, the determining may be operated by parameters of the preconfigured multi-parameter rule, e.g., product type and country, as shown in the screenshot of channel configuration GUI 600B in FIG. 6B and data of the customer that is retrieved from the database of customers details as shown in FIG. 7A-7B.

According to some embodiments of the disclosure, operation 220 may comprise sending the determined digital-survey-channel type to an API such as the outbound-message API 140 in FIG. 1 to trigger the digital survey to a computerized device of the customer, e.g., a computerized device 170 in FIG. 1, via the determined digital-survey-channel type.

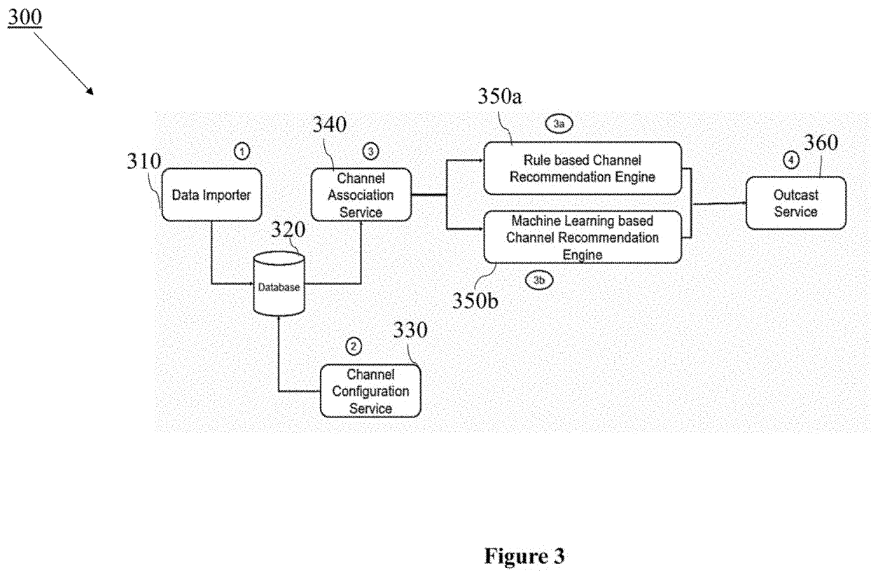

FIG. 3 is a high-level workflow of a data flow between different services 300, in accordance with some embodiments of the present disclosure.

According to some embodiments of the disclosure, a data storage, such as database 320 may store data from a data importer, such as data importer 310. The data importer, such as data importer 310 may be an interface which is exposed to external systems, via Secure File Transfer Protocol (SFTP), for file upload and Application Programming Interface (API), for interacting over web or through Customer Relationship Management (CRM) systems.

According to some embodiments of the disclosure, the data may be sent over a file such as Comma Separated Values (CSV) or JavaScript Object Notation (JSON) file format. This data may include details of customers to be surveyed, such as personal information, profile details, geographical information, preferences, and other fields.

According to some embodiments of the disclosure, the data importer, such as data importer 310, may validate the data before importing it to the database, and once the data is validated it is processed and stored in database 320 for further use.

According to some embodiments of the disclosure, a channel configuration service, such as channel configuration service 330, may be used to define multi-parameter rules for channel association service, such as channel association service 340 and such as digital-survey-channel-selection module 200 in FIG. 2, and such as digital-survey-channel-selection module 110 in FIG. 1.

According to some embodiments of the disclosure, a channel configuration service 330, may create JSON rule file and may store it in a data store, such as database 320. These multi-parameter rules may be used by a rule-based channel recommendation engine 350a to identify a digital channel type that may yield a maximum response rate, based on customer profile and preferences. The multi-parameter rules may be chronologically ordered based on their creation time, and whichever rule's conditions matches first may be associated to a nominated customer.

According to some embodiments of the disclosure, a channel association service, such as channel association service 340, may identify, i.e., determine the digital channel type based on customers profile and preferences. The determining of a digital channel type, may be dynamic, e.g., by an ML algorithms-based recommendation engine 350b or based on a preconfigured multi-parameter rule, such as rule based recommendation engine 350a.

According to some embodiments of the disclosure, rule-based recommendation engine 350a, may be operated when a customer may be nominated for a digital survey, after the customer completes an interaction at a touchpoint, such as an agent, a website, an automated chat channel or a store.

According to some embodiments of the disclosure, when the determining is preconfigured to be rule based i.e. manual, a digital channel type may be determined, e.g., may be associated to a customer, by executing a set of rules. The channel association service 340 may use java script-based engine, which may take customer data and a set of multi-parameter rules as input. The channel association service 340 may go over a set of multi-parameters rules and may evaluate them one by one using customer data and may associate the digital channels which match the criteria of the rule. Meaning, the association of the digital channels may be operated based on the rule's criteria and historical data which may be retrieved from a data storage, such as database of customers details 130 in FIG. 1, for example as shown in FIGS. 7A-7B. The set of multi-parameter rules may be chronologically ordered based on their creation time, and whichever rule's conditions matches first may be associated to a customer.

According to some embodiments of the disclosure, the digital channel type may be for example, text messaging such as WhatsApp, Facebook messenger, Messenger, Short Message Service (SMS), but not limiting to among other digital channel types.

According to some embodiments of the disclosure, the determined digital channel type may be sent to an outcast service 360, such as an outbound-message API 140 in FIG. 1, to trigger the digital survey to a computerized device of the customer, via the determined digital-survey-channel type.

According to some embodiments of the disclosure, when the determining is preconfigured to be dynamic, and the determining is operated by Machine learning (ML) based channel recommendation engine 350b, the ML based channel recommendation engine 350b may (i) predict customers-response-probability for each digital-survey-channel type of the plurality of digital survey channel types, based on one or more features, which are retrieved from the database of survey responses and the database of customers details; and (ii) select the digital-survey-channel type that is having a highest predicted customers-response-probability.

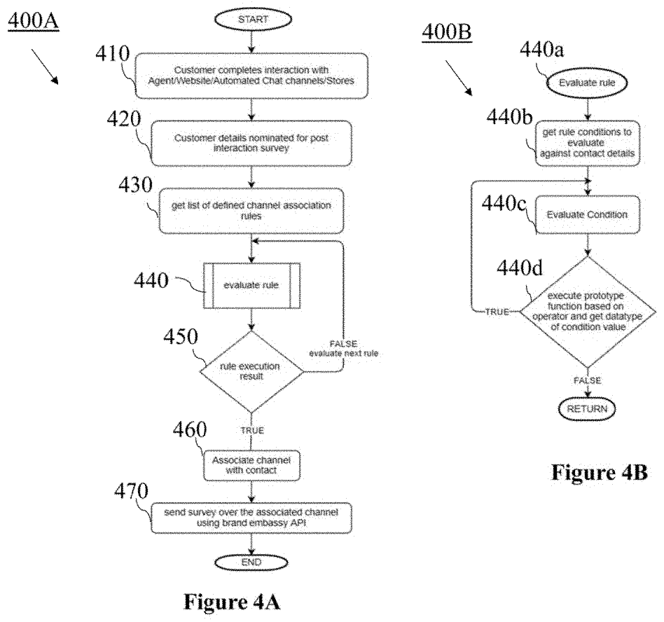

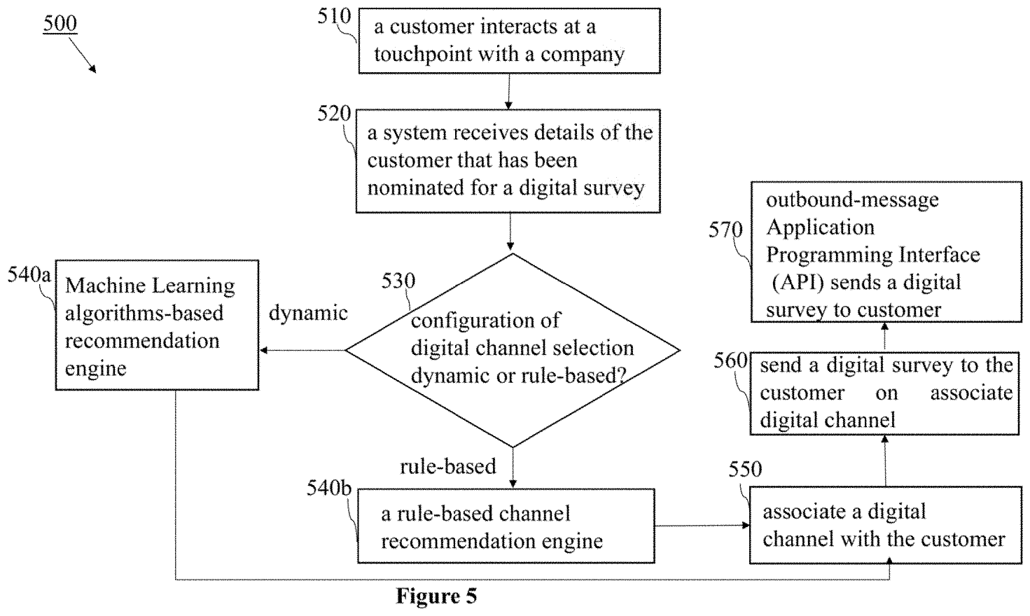

FIG. 4A is a high-level workflow of decision flow of rule-based engine 400A, in accordance with some embodiments of the present disclosure.

According to some embodiments of the disclosure, when a customer completes an interaction at a touchpoint, e.g., with an agent or via a website or via automated chat channels or in stores 410, customer details may be nominated for post interaction survey 420. Then, the rule-based engine 400A may get a list of defined channel association rules 430 and may evaluate rule 440, as described in detail in the workflow of rule evaluation 400B, in FIG. 4B.

According to some embodiments of the disclosure, the rule-based engine 400A may check rule execution result 450. If it is false, then the rule-based engine 400A may evaluate next rule 440. If it is true, the rule-based engine 400A may associate a digital channel with a contact 460. Then, the rule-based engine 400A may send a digital survey over the associated digital channel using, an Application Programming Interface (API), such as brand embassy API 470. Brand embassy is a digital customer engagement platform.

FIG. 4B is a high-level workflow of rule evaluation 400B, in accordance with some embodiments of the present disclosure.

According to some embodiments of the disclosure, evaluate a rule 440a may be operated by getting rule conditions to evaluate against contact details 440b, then evaluate condition 440c and then execute prototype function based on an operator and get datatype of condition value 440d. When the value is ‘true’ then repeating operations 440c-440d to evaluate next rule condition, and when the value is ‘false’, returning the rule evaluation result as false and proceed to next rule evaluation.

According to some embodiments of the disclosure, if all rule conditions in evaluate rule 440a evaluated by repeating operation 440c-440d are resulted into true, then the rule execution result 450 is true.

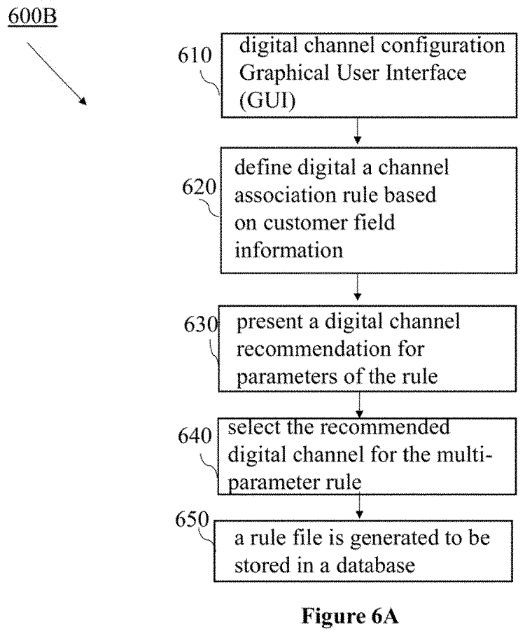

FIG. 5 is a high-level workflow of channel association and send survey 500, in accordance with some embodiments of the present disclosure.

According to some embodiments of the disclosure, a customer may interact at a touchpoint with a company 510, e.g., via a contact center or website or store. The interaction via the website may be chat with a representative or purchase or login etc.

According to some embodiments of the disclosure, a system, such as a system for a dynamic digital-survey-channel selection 100, may receive details of the customer that has been nominated for a digital survey 520.

According to some embodiments of the disclosure, the configuration of digital channel selection may be checked if it is dynamic or rule-based 530.

According to some embodiments of the disclosure, when the configuration of digital channel selection is rule-based, a rule-based channel recommendation, such as rule based channel recommendation engine 540b and such as rule based channel recommendation engine 350a in FIG. 3, may be operated.

According to some embodiments of the disclosure, when the configuration of digital channel selection is dynamic, a Machine Learning (ML) algorithms based recommendation engine, such as ML algorithms based recommendation engine 540a and such as ML based channel recommendation engine 350b in FIG. 3, may be operated.

According to some embodiments of the disclosure, the selected digital channel may be associated with the customer 550 and the digital survey may be sent to the customer on the associated digital channel 560 via an Application Programming Interface (API), such as outbound-message API 570.

According to some embodiments of the disclosure, once a digital channel has been determined the system, such as a system for a dynamic digital-survey-channel selection 100, an outcast service, such as outcast service 360 in FIG. 3 may trigger an integration of a platform and may call the platform's API. The embedded platform may be Brand Embassy, which may rely the digital survey to the customer on which the customer has the highest probability of responding.

FIG. 6A is a high-level workflow of a channel configuration flow 600A, in accordance with some embodiments of the present disclosure.

According to some embodiments of the disclosure, a digital channel configuration Graphical User Interface (GUI) 610, such as the GUI shown in the screenshot of channel configuration GUI 600B in FIG. 6B, may be used by a user such as a program manager, to define rules related to a digital survey. A program manager may be a system user with permission to design the digital survey and define rules related to the digital survey.

According to some embodiments of the disclosure, the program manager may define a digital channel association rule based on customers field information 620, e.g., profile and preferences. For example, the customer filed information may be retrieved from a data storage, such as the database of customers details 130 in FIG. 1 and as shown in FIGS. 7A-7B.

According to some embodiments of the disclosure, while defining one or more rules, the system, such as a system for a dynamic digital-survey-channel selection 100, may present a recommended digital channel 630 via the digital channel configuration GUI, as the GUI shown in a screenshot of channel configuration GUI 600B in FIG. 6B, by operating historical data analysis of customer's profile and preferences. The presented digital channel may be the best suited digital channel which may maximize the response rate.

According to some embodiments of the disclosure, the program manager may select the recommended digital channel type for the multi-parameter rule 640. For example, the recommendation may be recommendation 630 in FIG. 6B. The program manager may also select another option instead of recommended digital channel type based on business campaigns that are planned to run. Once one or more digital channel association rules are defined, a rule file may be created and stored in database 650, such as database 320 in FIG. 3, to use it later in rule-based channel identification flow.

FIG. 6B is a screenshot of channel configuration Graphical User Interface (GUI) 600B, in accordance with some embodiments of the present disclosure.

According to some embodiments of the disclosure, during a configuration of a digital-survey-channel type and other parameters of the preconfigured multi-parameter rule via an interface, such as shown in the screenshot of channel configuration Graphical User Interface (GUI) 600B, by a user, the system, such as a system for a dynamic digital-survey-channel selection 100 may operate a module, such as digital-survey-channel-selection module 110 in FIG. 1 and such as digital-survey-channel-selection module 200 in FIG. 2 to select a digital-survey-channel type.

According to some embodiments of the disclosure, when the digital-survey-channel type that was configured by the user is different from the selected digital-survey-channel type, the selected digital-survey-channel type may be displayed via the interface, as part of a recommendation for a digital-survey-channel type. For example, the user, such as a program manager may select a digital channel for a survey to be conducted via Whatsapp, if this channel is different from the selected digital-survey-channel type e.g. SMS, the selected digital-survey-channel type may be displayed via the interface, as part of a recommendation for a digital-survey-channel type.

According to some embodiments of the disclosure, the selecting of the digital-survey-channel type may be operated by: (i) retrieving ‘n’ data entries from the database of customers details, according to the other parameters of the preconfigured multi-parameter rule and a preconfigured period of time; and (ii) predicting a customers-response-probability for each digital-survey-channel type of the plurality of digital survey channel types, based on the retrieved ‘n’ data entries.

According to some embodiments of the disclosure, the retrieved ‘n’ entries may be for example, ‘n’ entries in a database according to parameters of the preconfigured multi-parameter rule 700 in FIGS. 7A-7B. The parameters may be location based features 750 and product level feature 730 for the rule that is shown in the screenshot of channel configuration GUI 600B having rule criterion for product type equals retail 620a and another criterion for country is any of UK, US 620b.

According to some embodiments of the disclosure, the predicting of the customers-response-probability for each digital-survey-channel type of the plurality of digital survey channel types may be operated by: (i)applying a digital-survey-channel type for each data entry, from the ‘n’ data entries, to predict by ML models a customers-response-probability for each data entry and then calculating an average customers-response-probability for the ‘n’ data entries for each digital-survey-channel type; and (ii)selecting a digital-survey-channel type from the plurality of digital survey channel types based on a highest average customers-response-probability.

FIGS. 7A-7B are screenshots of ‘n’ entries in a database retrieved according to parameters of the preconfigured multi-parameter rule 700, in accordance with some embodiments of the present disclosure.

According to some embodiments of the disclosure, the ‘n’ entries in a database retrieved according to parameters of the preconfigured multi-parameter rule 700 may include features such as survey medium feature 720, product level feature 730, demographic features 740 and location-based features 750.

According to some embodiments of the disclosure, the target 710 may be a response category which is an actual value that indicates if the customer has responded to the digital survey.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to coverall such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

1. A computerized-method for a dynamic digital-survey-channel selection, said computerized-method comprising:
in a computerized system having a processor, a memory to store a database of survey responses and a database of customers details, and a Voice of the Customer (VOC) platform having an outbound-message Application Programming Interface (API) to send a digital survey to a customer, via a plurality of digital survey channel types,
when a customer is nominated for a digital survey, operating by said processor, a digital-survey-channel-selection module, said digital-survey-channel-selection module comprising:
(i) determining a digital-survey-channel type to elevate customers-response-rate to a digital survey; and
(ii) sending the determined digital-survey-channel type to the outbound-message API to trigger the digital survey to a computerized device of the customer, via the determined digital-survey-channel type.

2. The computerized-method of claim 1, wherein the determining is preconfigured to be (i) dynamic;
or (ii) based on a preconfigured multi-parameter rule.

3. The computerized-method of claim 2, wherein when the determining is preconfigured to be dynamic, the determining is operated by Machine learning (ML) models and performed by:
(i) predicting customers-response-probability for each digital-survey-channel type of the plurality of digital survey channel types, based on one or more features, which are retrieved from the database of survey responses and the database of customers details; and
(ii) selecting the digital-survey-channel type that is having a highest predicted customers-response-probability.

4. The computerized-method of claim 1, wherein the determined digital-survey-channel type is associated with the customer and a digital survey is sent via the outbound-message API, to the computerized device of the customer, via the associated digital-survey-channel type.

5. The computerized-method of claim 2, wherein when the determining is based on a preconfigured multi-parameter rule, the determining is operated by parameters of the preconfigured multi-parameter rule and data of the customer that is retrieved from the database of customers details.

6. The computerized-method of claim 2, wherein during a configuration of a digital-survey-channel type and other parameters of the preconfigured multi-parameter rule via an interface, by a user, the computerized method is further comprising selecting a digital-survey-channel type and when the digital-survey-channel type that was configured by the user is different from the selected digital-survey-channel type, the selected digital-survey-channel type is displayed via the interface, as part of a recommendation for a digital-survey-channel type.

7. The computerized-method of claim 6, wherein the selecting of the digital-survey-channel type is operated by:
(i) retrieving ‘n’ data entries from the database of customers details according to the other parameters of the preconfigured multi-parameter rule and a preconfigured period of time; and
(ii) predicting a customers-response-probability for each digital-survey-channel type of the plurality of digital survey channel types, based on the retrieved ‘n’ data entries.

8. The computerized-method of claim 7, wherein the predicting of the customers-response-probability for each digital-survey-channel type of the plurality of digital survey channel types is operated by: (i) applying a digital-survey-channel type for each data entry, from the ‘n’ data entries, to predict by ML models a customers-response-probability for each data entry and then calculating an average customers-response-probability for the ‘n’ data entries for each digital-survey-channel type; and (ii) selecting a digital-survey-channel type from the plurality of digital survey channel types based on a highest average customers-response-probability.

9. The computerized-method of claim 1, wherein the customer is nominated for the digital survey after an interaction at a touchpoint of at least one of: an agent, a website, an automated chat channel and a store.

10. A computerized-system for a dynamic digital-survey-channel selection, said computerized-method comprising:
a processor;
a memory to store a database of survey responses and a database of customers details; and
a Voice of the Customer (VOC) platform having an outbound-message Application Programming Interface (API) to send a digital survey to a customer, via a plurality of digital survey channel types,
when a customer is nominated for a digital survey, said processor is configured to operate a digital-survey-channel-selection module,
said digital-survey-channel-selection module is configured to:
(i) determine a digital-survey-channel type to elevate customers-response-rate to a digital survey; and
(ii) send the determined digital-survey-channel type to the outbound-message API to trigger the digital survey a computerized device of to the customer, via the determined digital-survey-channel type.
